(19) United States
(12) Patent Application Publication
(10) Pub. No.: US 2008/0243459 A1
(43) Pub. Date: Oct. 2, 2008

(54) Optimization Using Indirect Design Coding

(75) Inventors: Bernhard Sendhoff, Bruchkobel (DE); Till Steiner, Morfelden (DE)

Correspondence Address: FENWICK & WEST LLP, SILICON VALLEY CENTER, 801 CALIFORNIA STREET, MOUNTAIN VIEW, CA, 94041, US

(73) Assignee: Honda Research Institute Europe GmbH, Offenbach/Main (DE)

(21) Appl. No.: 12/057,169

(22) Filed: Mar. 27, 2008

(30) Foreign Application Priority Data
Mar. 30, 2007 (EP) 07105378
Apr. 19, 2007 (EP) 07106515

(51) Int. Cl. G06G 7/60

(52) U.S. Cl. 703/11

(57) ABSTRACT

A method for optimizing a material structure. The method comprises the steps of encoding an initial design of the material structure to be optimized as a parameter set, subjecting the initial design to an optimization according to at least one preset criterion, using an evolutionary algorithm, terminating the optimization when a termination condition is met, and outputting data representing the optimized parameter set. The design of the material structure is encoded indirectly as a virtual DNA.

### RELATED APPLICATIONS

This application claims priority under 35 U.S.C. § 119(a) to European Patent Application number 07 105 378, filed on Mar. 30, 2007, and European Patent Application number 07 106 515, filed on Apr. 19, 2007, which are incorporated by reference herein in their entirety.

### FIELD OF THE INVENTION

The present invention is related to optimization of physical bodies, more specifically to optimization of an internal structure of physical bodies.

### BACKGROUND OF THE INVENTION

Evolutionary algorithms have been successfully employed in various fields including, among others, technical optimization, operations research, and design optimization. In particular, innovative technical design solutions were obtained in the field of design optimization by using evolutionary algorithms in combination with appropriate simulation tools such as computational fluid dynamics.

The complexity of the design, however, is limited when using the evolutionary algorithms because in most cases (for example, spline representation), the complexity is governed by the dimension of the search space. Alternative representations such as free form deformation allow shapes of unrestricted complexity to be designed. The free form deformation, however, does not allow unrestricted changes in the shape. Further, it is also difficult to constrain the design to shapes and structures with certain properties that may be desirable in some cases (for example, symmetry, self-similarity or properties that reflect constraints of the physical world).

### SUMMARY OF THE INVENTION

Embodiments of the present invention provide an improved design optimization approach particularly adapted for optimization of the inner structures of physical bodies.

In one embodiment of the present invention, a method for optimizing the internal structure of a body includes: (a) encoding an initial design of the internal structure to be optimized as a parameter set; (b) subjecting the parameter set of the initial design to an optimization according to at least one preset criterion using an Evolutionary Algorithm; (c) terminating the optimization when a termination condition is met; and (d) outputting data representing the optimized parameter set. The design of the internal structure is encoded indirectly as a virtual genotype. The parameters of the virtual genotype describe a cell growth development of the phenotype in a gene regulatory network. Therefore, the virtual genotype represents an indirect coding of the internal structure, for example, by the interaction behavior in the gene regulatory network.

In one embodiment of the present invention, the internal structure comprises voids.

In one embodiment of the present invention, the step of (e) building the body having the internal structure of the optimized parameter set is also performed.

In one embodiment of the present invention, the internal structure is a two dimensional cross-section of the body or a three-dimensional internal structure of the body.

In one embodiment of the present invention, the step (b) of subjecting the parameter set of the initial design to an optimization includes repeating the following steps: (i) producing offspring of a genotype, (ii) developing cell growth until a development termination criterion is met (the development is directed by the genotype, leading to the phenotype of the offspring individuals), (iii) computing a fitness value of the grown phenotype, and (iv) selecting the individuals according to their fitness value and a selection strategy (for example, highest fitness value) for the subsequent offspring production step.

In one embodiment of the present invention, the step of producing offspring from a parent individual is at least one of (i) mutation of the genotype, (ii) crossover with another individual, (iii) gene transposition, and (iv) gene duplication. Therefore, the production of offspring individuals occurs at the genotype level and not at the phenotype level.

A development termination condition is met, for example, when (i) the cell growth development reaches a predetermined number of discrete steps or (ii) the cell growth development converges into a stable structure (i.e., the change in the cell growth development between two subsequent steps is lower than a predetermined threshold).

In one embodiment of the present invention, the cells represent the presence of material or holes at a defined position.

In one embodiment of the present invention, the cells represent different materials. For example, the material type can be encoded in the genotype of an individual, and thereby be differentiated in different cells of an individual.

In one embodiment of the present invention, after terminating the cell growth development, the phenotype of the internal structure can be smoothened. The cells represent control points of a higher order spline surface or other smoothing methods.

In one embodiment of the present invention, the material boundary of materials of different type or holes is represented by patches from a number of different spline surfaces.

In one embodiment of the present invention, the cells move according to the forces applied by other cells or the environment during the cell growth development.

In one embodiment of the present invention, the cells may interact physically in the form of rigid body interaction during the cell growth development.

In one embodiment of the present invention, the cells may be pushed aside when a division occurs and may reach a new stable arrangement afterwards during the cell growth development.

In one embodiment of the present invention, the number of parameters of the genotype varies during the course of the optimization. That is, adaptive number of parameters is allowed.

In one embodiment of the present invention, the parameters of the genotype define the activity and the action type of a cell during the cell growth development.

In one embodiment of the present invention, the activity is at least one of divide, die, release transcription factor (TF) and produce a cell adhesion function.

In one embodiment of the present invention, the activity is the cell assuming one out of a plurality of different material types allowed for optimization of the body.

In one embodiment of the present invention, the Evolutionary Algorithm is an Evolution Strategy.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the present invention can be readily understood by considering the following detailed description in conjunction with the accompanying drawings.

FIG. 1 is a diagram illustrating a vDNA, according to one embodiment of the present invention.

FIG. 2 is a diagram illustrating a gene regulatory network, according to one embodiment of the present invention.

FIG. 3 is a series of diagrams illustrating interactions inside the dynamic gene regulatory network, according to one embodiment of the present invention.

FIG. 4 is a diagram illustrating an example of developing the fitness as a function of the optimization cycle (generation) number, according to one embodiment of the present invention.

FIG. 5 is a flow chart illustrating a method, according to one embodiment of the present invention.

FIG. 6 is a diagram illustrating different stages of the cell growth development of a phenotype, according to one embodiment of the present invention.

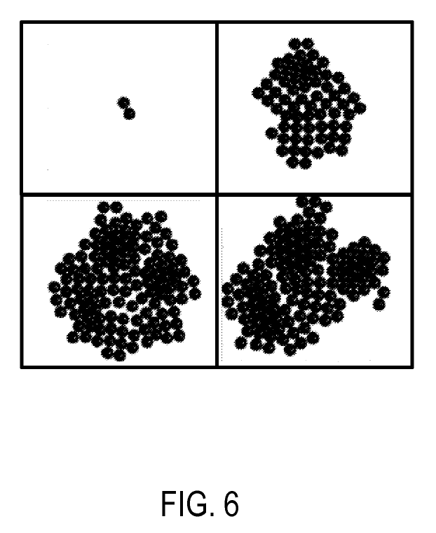

### DETAILED DESCRIPTION OF THE INVENTION

A preferred embodiment of the present invention is now described with reference to the figures where like reference numbers indicate identical or functionally similar elements.

Reference in the specification to “one embodiment” or to “an embodiment” means that a particular feature, structure, or characteristic described in connection with the embodiments is included in at least one embodiment of the invention. The appearances of the phrase “in one embodiment” in various places in the specification are not necessarily all referring to the same embodiment.

Some portions of the detailed description that follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

In addition, the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims. Effectors include manipulators in industrial robots. In humanoid robotics, the effector is often defined as a reference point of the hand such as the finger tip. The effector could also be the head, which is controlled to face a certain point or in certain direction.

In one or more embodiments of the present invention, a parameter set representing an optimized design of a physical body is obtained. This optimized parameter set may then be translated into a real world physical body. The optimization may be carried out using a conventional Evolutionary Algorithm that is well known to a person skilled in the art.

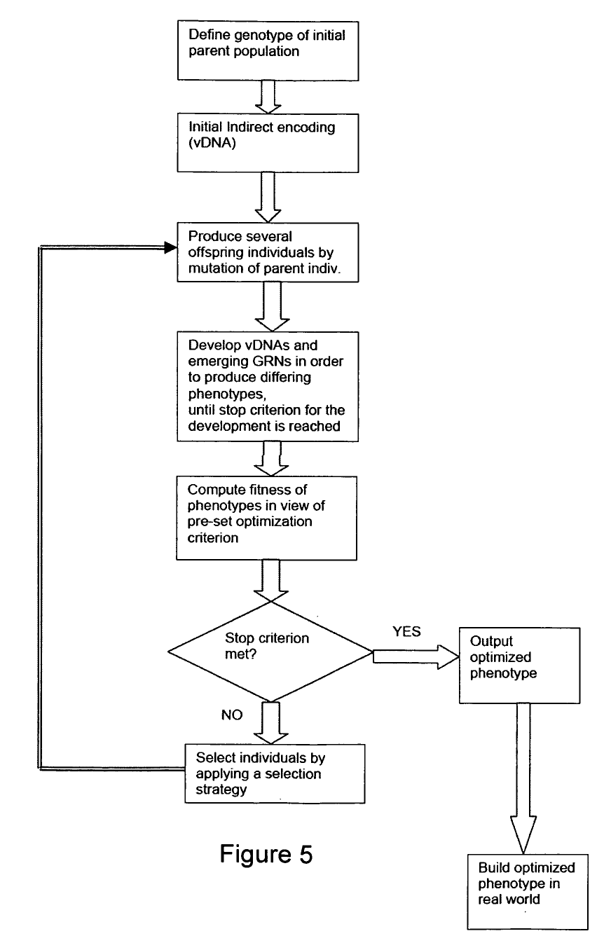

With reference to FIG. 5, a general layout of the method according to the present invention is described below.

It is an object of this method to generate data representing the structure of an optimized physical body. The “optimized physical body” is to be understood as a physical body that is optimized in cyclic iterative steps in view of one or a plurality of (multiple) objectives.

In the first step, a population of individuals is defined. Each individual contains a virtual DNA (vDNA) as genotype. The vDNA is the basis for the gene regulatory network (GRN) that controls the growth process of the individuals. In order to define a GRN, the input and output behavior of virtual cells and the interaction mechanisms between the cells need to be defined.

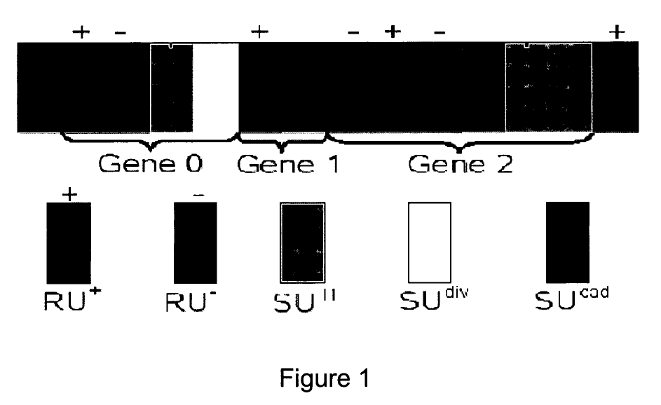

In a second step, a population of initial non-optimized designs is indirectly encoded as the vDNA of the individuals. The vDNA comprises a plurality of genes (see FIG. 1), each consisting of, for example, a plurality of structural subunits (SU) and regulatory subunits (RU). Thus, input behavior, output behavior and the interaction between the cells are encoded via the genes of the vDNA. This encoding is called “indirect encoding” as the parameters (values inside the genes) of the vDNA do not directly encode the shape of an individual (for example, via the coordinates of splines, the angles of flaps of a wing, etc.) but rather provides a construction plan using which the shape is grown. The encoding is indirect because in order to develop the phenotype, a cell with such vDNA must first undergo a cell growth development process to produce the phenotype.

The initial genome of the vDNA may, for example, be set up by randomly allocating values to all subunits of the genes of the virtual DNA. An alternative is to set all values on an average value or use a hand coded genotype as well as a genotype that proved useful during previous evolutionary runs.

It is well known in evolutionary algorithms that several offspring individuals are then produced from this initial population of individuals referred to as parent population. It is also well known that the several offspring individuals will differ slightly from each other (and from the initial parent individuals) because the offspring production process usually comprises some random influence such as mutation. Thus, this offspring generation will have at least two individuals with usually slightly different vDNAs.

Note that in the case of the direct encoding (for example, spline encoding) of known evolutionary algorithms, the direct encoding of the individuals may be mapped directly to phenotype designs. The fitness of these differing phenotypes may be assessed or computed by applying a fitness function.

In contrast, in view of the indirect encoding of the present invention, the individuals of the offspring population have to be developed (cell growth development) using a gene regulatory network in order to produce differing phenotypes. The cell growth development is terminated when a development termination condition is met. The development termination condition, for example, is reaching of a preset number of developmental steps or stabilization of the cell growth development process (i.e., the difference between two subsequent steps is smaller than a preset development change threshold). At the end of the cell growth development step, each individual of the population grows a phenotype that generally differs from the phenotypes of other individuals.

Then, a fitness function (well known in evolutionary algorithms) may be applied to the differing phenotypes to assess the fitness in view of at least one preset optimization criterion. The fitness function outputs a computed fitness value for each of the offspring phenotypes.

If the termination criterion for the optimization cycle is not reached, individuals of this offspring population are subject to selection. According to the fitness values and a selection strategy, a subset of individuals is chosen to serve as new parent population for subsequent iterations of the optimization loop.

In one embodiment, the fitness assessment and the selection are made using an assessment on the phenotypes. The offspring generation (including mutation) is carried out at the vDNA level. This is different from conventional evolutionary algorithms in which the genotype and the phenotype are directly linked and a change in phenotype yields a directly predictable change in the phenotype.

If an optimization termination condition is met after the fitness assessment, the optimization cycle terminates. The optimization termination condition can be, for example, (i) reaching of a preset maximum number of optimization cycles, (ii) satisfying a convergence criterion (i.e., the fact that the fitness value of the best phenotypes of subsequent optimization cycles shows a difference which is smaller than a preset convergence threshold) or (iii) reaching of a required fitness value.

When the optimization cycle is terminated, data representing the optimized phenotype or the vDNA of the optimized phenotype can be outputted.

These data can then be used as a two-dimensional cross section or three-dimensional representation of the corresponding physical body to be built.

In one or more embodiments of the present invention, the modeling of cellular development is conducted by Gene Regulatory Networks (GRNs) for evolutionary shape or structure optimization.

In one or more embodiments of the present invention, the developmental process that uses cells as phenotypic representation is used for design optimization. The genotype of an individual represents a vDNA. The individual is subject to the process of evolution using an Evolutionary Algorithm. The genotype (vDNA) describes the developmental process of a growing phenotype rather than its final appearance. Generally, individuals grow in discrete steps (developmental time steps) from one cell to the final shape using simulated physical and chemical cell-cell interactions such as simulated transcription factors and simulated adhesion forces between cells.

### Environment

The optimization process starts from the definition of an environment (“virtual egg”) that provides the physical environment for the simulation of development. The environment is in the form of a cube (x, y and z directions) with fixed boundaries. At the beginning of the development, a virtual egg contains one single cell in the shape of a ball of a fixed radius at the center of the cube. Generally, cell positions are determined by floating point values for x, y and z, and are in general affected by the forces exerted by other cells. Therefore, the cells may move during the developmental process.

### Cell

Cells are entities that represent the phenotype because positions of the cells are evaluated for fitness computation. All cells inside one virtual egg contain the same vDNA. The cells are capable of dividing, which means that a new cell is placed close to the first cell. The exact position of the new cell depends on genetic information and the position and forces of other cells.

The cells are capable of producing a number of transcription factors that diffuse inside the egg. After apoptosis (i.e., genetically induced cell death), the cell is removed from the virtual egg.

Virtual DNA (vDNA)

The virtual DNA is a vector of genes. Each gene consists of a random number of structural units (SU) and several regulatory units (RU). The structural units provide information for the cell's actions. The regulatory units act as controlling entities. The activation function of the regulatory units is evaluated in every developmental time step. Specifically, depending on the presence of transcription factors, all regulatory units of one gene contribute to its overall activity. That is, they determine whether a gene is active or inactive at the position where the cell is located.

### Transcription Factors

Transcription factors (TFs) are simulated chemicals that consist of a type aTF, a distribution of concentrations that is associated with every point of a diffusion grid d, a diffusion constant D, and a decay rate g. The type is used to compute a chemical distance to the regulatory units. Therefore, a transcription factor with a small chemical distance to a regulatory unit has a greater influence on that unit than TFs with larger distances. This ensures that regulatory units will react specifically to certain TFs as described below in detail.

Evolutionary optimization in a developmental process according to embodiments of the present invention combines evolutionary computation with cell growth development. In this approach, an artificial genotype encodes the developmental process through Gene Regulatory Networks (GRNs) resulting in an indirect representation that is different from traditional evolutionary algorithms (EAs).

### Process of Development

The model according to embodiments of the present invention is based on extensions of the model disclosed, for example, in T. Steiner, M. Olhofer, and B. Sendhoff, “Towards shape and structure optimization with evolutionary development,” In Proceedings of the Tenth International Conference on the Simulation and Synthesis of Living Systems, pages 70-76, 2006, which is incorporated by reference herein in its entirety. There are two major extensions from the method disclosed in this article: (i) implementation of physical interactions between cells, and (ii) modifications to the genetic representation so that the model becomes biologically more plausible.

### Genetics

According to the embodiments of the present invention, cellular growth is controlled by a genome stored in a virtual DNA (vDNA). An identical copy of the vDNA is available for translation to all cells in an individual.

This genome consists of regulatory subunits (RUs) and structural subunits (SUs), which are initially lined up in a random order. The functional unit of this DNA, called a gene, is composed of a group of SUs and the preceding RUs. The SUs encode actions that a cell should perform while the RUs determine whether a gene is active or not. The actions encoded in the gene will be performed only if the gene is active.

An illustrative example of a genome with three genes is shown in FIG. 1. This Figure shows a vDNA with three genes, each consisting of one or more structural subunits (SUs) and regulatory subunits (RUs). Two different types of RUs exist: (i) inhibitor (RU−), and (ii) activator (RU+). A SU coding for the production of a transcription factor (TF) is denoted by SUTF, a SU coding for a division by SUdiv and a Cadherin producing SU by SUcad.

Structural subunits: A SU encodes the action to be performed, and contains the parameters that specify the action. Possible actions include cell division, production of a diffusing chemical, the transcription factor (TF) for cell-cell signaling, and production of Cadherin molecules on the cell surface, which determine cell-cell adhesion forces.

Formally, a SU consists of a five element vector x with entries xᵢε[0 . . . 1], i=1, . . . , 5. x₁ is used to determine the type t of action encoded by the SU:

$$t = \{ \begin{matrix}1 & ∀ x \text{:} & 0 \leq {x}_{1} < \frac{1}{3} \\ 2 & ∀ x \text{:} & \frac{1}{3} \leq {x}_{1} < \frac{2}{3} \\ 3 & ∀ x \text{:} & \frac{2}{3} \leq {x}_{1} < 1\end{matrix}$$

If t=1, a cell division is encoded. x₂ is used to determine the division angle while the values x₃ to x₅ remain unused. If t=2, a TF is to be produced. x₂ encodes an affinity label assigned to the TF (aff_{TF}), x₃ is the amount of TF to be released, x₄ is a diffusion constant, and x₅ is a decay rate. In case where t=3, Cadherin molecules are to be produced by the gene, and the type of Cadherin is determined by x₂.

Cells containing the same type of Cadherin will adhere to each other. Note that for t=2, not all xᵢ are used but they are still kept as a part of the SU. This means that mutation affects them but they are not subject to selection pressure. The reason for keeping all xᵢ is that a mutation in x₁ can yield t=2, where five values are needed for the production of the TF. Comparison of this pragmatic to other possibilities were not yet explored (for example, to a random re-initialization of x₂ to x₅ when x₁ causes a change in t).

Regulatory subunits: Two types of RUs are used in the model, which either increase (activate) or decrease (inhibit) the expression of a gene. The RUs can sense the presence of certain types of TFs in the vicinity of the cell. If the label of a TF is affine to a label associated with the RU and the concentration of the TF lies above a threshold, an activity value is determined for each RU. All activating (=positive sign) and inhibiting (=negative sign) activity values belonging to the same gene are summed up to determine the overall activity of the gene.

Cells and their Interaction

The simulation area for cellular growth is defined by a square (2D) or a cube (3D) that is discretized by an equally spaced grid (for example, step-size=0.5) on which the concentrations of the TFs are allocated. The cells are modeled, for example, as spheres having a radius of one. The cells interact with each other by reading and releasing TFs and by cellular motion through rigid body interactions coupled with adhesion forces.

No deformation to the spheres is allowed. Instead, a small overlap between neighboring cells is allowed. Note that the cell positions are not fixed to a grid. Therefore, they read the concentrations of TFs from the four nearest nodes of the diffusion grid and interpolate its actual value. The release of a TF by a cell is simulated by an increase of concentration in the four nearest nodes on the diffusion grid.

In one embodiment of the present invention, the implemented mechanism for cell adhesion is as follows: If two cells contain the same type of Cadherins (which means that they express the same gene), the cells will adhere to each other.

There are several alternative models available for the simulation of cellular growth and their interaction. For example, the cells may be modeled as pixels on a fixed grid. A spring mass-damper system is employed to simulate the shape and physical behavior of plant cells. As described above, different cell models require the evolution of different control mechanisms, resulting in different gene regulatory systems with varying properties.

In one embodiment of the present invention, a cell can always perform the actions that its genome activates. In contrast, it may be the case that a division does not take place in the pixel model because the space for the new cell is already occupied by another cell. Therefore, the control of activation for such a gene would no longer evolve because its function is automatically disabled.

### Time Scales and Sequence of Events

At the beginning of the development, a single cell containing the vDNA is placed at the center of the simulation area. To start the growth process, an initial TF (maternal TF) is released, which maintains a constant concentration in the whole area over the entire developmental time. Contrary to most existing models, the initial TF concentration in the embodiments of the present invention does not provide any positional information. Rather, it satisfies the minimal requirement for starting a developmental process.

In each developmental step, the following events take place: First, the translation of the DNA is initialized for all existing cells. Secondly, if the TFs in the vicinity of the cell activate a gene, the action encoded in the gene is executed. Finally, the position of all cells is updated and the diffusion of the released chemicals is simulated.

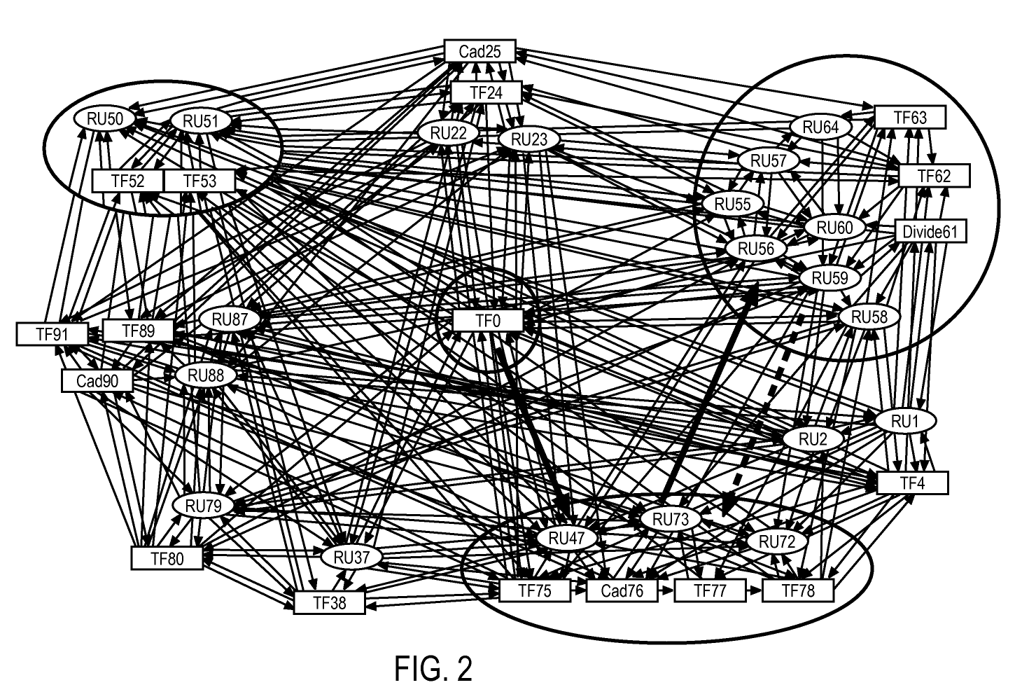

FIG. 2 illustrates the static interaction network of an individual from generation 43, according to one embodiment of the present invention. The prediffused TF is placed at the center of the network. A close-up on one gene is shown in the upper left corner of the Figure. The gene consists of an inhibitory RU (black ellipses), an excitatory RU (white ellipses) and two TF-coding Sus (rectangles). Two interacting genes and the prediffused TF are emphasized by bold circles.

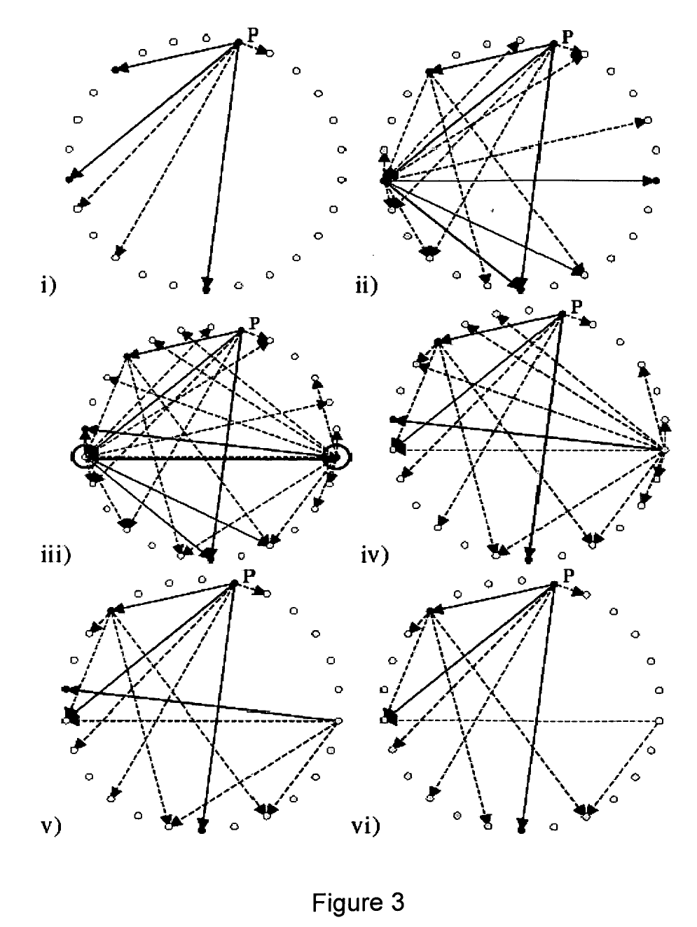

FIG. 3 illustrates a series of interactions inside the dynamic GRN, according to one embodiment of the present invention. Each gene is shown as a small circle. The point denotes the prediffused TF. Active genes are marked as filled circles. The interactions between the genes are either inhibitory (dashed arrows) or excitatory (solid arrows). In iii), two genes which form a negative feedback loop are highlighted, with an excitatory interaction from the left to the right and an inhibitory interaction in the opposite direction. Each part i) to vi) of FIG. 3 represents the state of the GRN in one time step. Note that the static condition for this individual is not yet reached after time step vi).

### Evolutionary Algorithm

An evolutionary strategy ((μ,λ)-ES) with individual strategy parameter adaptation may be adopted. Details of the evolution strategy can be found, for example, in Hans-Paul Schwefel, “Evolution and Optimum Search,” John Wiley, 1994, which is incorporated by reference herein in its entirety.

The main variation operator in the ES is the mutation operator that adds a normally distributed zero-mean random number to each object parameter. Each design variable has its own variance that self-adapts to the fitness landscape during evolution.

In contrast to conventional ESs, both gene transposition and gene duplication were implemented in the embodiments of the present invention. In one embodiment of the present invention, a transposition is achieved in the following way: two randomly chosen units (both SUs and RUs are possible) are marked. Then, all units between these two marked units are cut out and pasted to another randomly chosen position. Gene duplication is performed in a similar manner: only units between the markers are copied and pasted to another randomly chosen position. Gene transposition and gene duplication are implemented at a certain probability, which is denoted by pm·pt for transposition and pm·pd for duplication respectively where pd=1−pt.

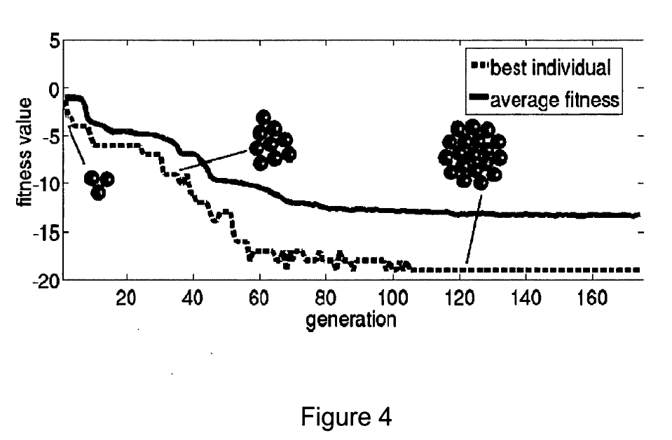

FIG. 4 illustrates the best (dashed line) and average (solid line) fitness of a typical evolutionary run, according to one embodiment of the present invention. The shape of simple individuals, after convergence to a stable state, is shown illustratively for three different generations.

### Growth Processes for Optimization of Structured Materials

Structured materials are integrated systems that serve multiple roles, such as structural load bearing, thermal management, and energy absorption. The structure materials exhibit a particular inner structure, which is the main reason for their superior characteristics over common materials.

Such inner structure can be described as specially shaped holes inside a material that are filled with another material/liquid/gas depending on the intended use of the material. Examples include lightweight, load bearing elements, thermal management and materials with integrated damping.

Designing of such structured materials includes optimizing the inner structure according to the needs and given constraints adapted for their functions.

In one embodiment, a strategy is devised for designing the shape and material properties used for the inner structure of functional materials for the uses mentioned above. Designing the number of holes along with the shapes of holes is a high-dimensional mixed integer optimization problem where the quality function is given by nonlinear physical properties of the resulting design. Testing the real world designs is expensive. Therefore a computational approach seems appropriate for parts of the developmental process. Construction of materials with voids or other materials enclosed therein is a complex undertaking. A strategy to produce these structures needs to be included in the design process.

Evolutionary development of internal structured patterns may be simulated with cellular growth. Then, real-world bodies can be built using rapid prototyping or extrusion of 2D patterns.

### EXAMPLES OF APPLICATION

Lightweight, yet stable structures: Voids inside a material can decrease its weight and lower the material cost. To maintain a desired stability however, the number, position and shape of voids must be chosen carefully. The evolutionary developmental approach is capable of finding such configurations, optimizing number, position and shape of voids at the same time. Such materials can find their application, for example, in aircrafts, automobiles, high-rise buildings, and marine-constructions. Furthermore, self-similar patterns of voids and holes that go beyond simple repetitive periodic patterns can be produced using the embodiments of the present invention.

Structures capable of heat transport: Heat transport in cooling devices is usually achieved by conduction or convection. A heat exchanger is designed in a way that a solid body conducts heat from the heat source and transports it to an outer or inner surface (pipe like passages) where a stream of fluid (for example, air) removes the heat. The size, number and shape of both the outer and the inner surfaces can be optimized such that a maximum heat transfer rate is achieved.

Lightweight structural elements with internal damping: Suppression of oscillations caused by vibrations is a feature of modern materials that is desirable in many industrial areas because oscillations can cause material and joint fatigue as well as annoying auditory sounds. Inserting structured damping elements inside the material helps reduce these oscillations, reducing its effects while minimizing effects on the stability of the material.

Micro tubular structure of air diffusers/flow distributors: In applications where a flow field with specified characteristics is needed (for example, wind tunnels and chemical reactors), fluids are guided by air diffusers and flow distributors. The layout of such devices usually includes tubes and nozzles that are optimized in its size, shape and number to produce the desired flow field.

Microscopic inner or surface structure of catalysts or membranes, supporting chemical reactions: In chemistry and biology, chemical reaction is accelerated by means of a substance called catalyst. Both the chemical characteristics of the material used as well as its surface structure may contribute to the improved performance of the catalyst.

The embodiments of the present invention may also be used for lab-on-a-chip and microfluidic devices such as micropump and microvalve devices that require an internal microstructure to optimize such characteristics as flow characteristics and fluid pockets.

While particular embodiments and applications of the present invention have been illustrated and described herein, it is to be understood that the invention is not limited to the precise construction and components disclosed herein and that various modifications, changes, and variations may be made in the arrangement, operation, and details of the methods and apparatuses of the present invention without departing from the spirit and scope of the invention as it is defined in the appended claims.

What is claimed is:

1. A method for optimizing an internal structure of a body, comprising:
(a) encoding an initial phenotype design of the internal structure as a parameter set, the initial phenotype design of the internal structure encoded indirectly as a virtual genotype having parameters describing cell growth development of the phenotype using a gene regulatory network;
(b) processing the parameter set of the initial phenotype design by an evolutionary algorithm according to at least one predetermined optimization criterion to generate an optimized parameter set, the processing of the parameter set terminated responsive to a termination condition of the evolutionary algorithm being met; and
(c) outputting data representing the optimized parameter set.

2. The method of claim 1, further comprising:
(d) building the body having the internal structure according to the optimized parameter set.

3. The method of claim 1, wherein the internal structure is a two dimensional cross-sectional internal structure of the body or a three-dimensional internal structure of the body.

4. The method of claim 1, wherein the step (b) of processing the parameter set comprises:
(e) producing one or more offspring individuals of the virtual genotype;
(f) developing cell growth of phenotypes of the offspring individuals by a gene regulatory network until a development termination criterion is met;
(g) computing a fitness value of the developed phenotypes;
(h) selecting a virtual genotype of the phenotype having best fitness value for producing offspring individuals in step (e); and
(i) repeating steps (e) to (h) until the termination condition of the evolutionary algorithm is met.

5. The method of claim 4, wherein the step (e) of producing the one or more offspring individuals comprises performing at least one of mutation, recombination, gene transposition, and gene duplication.

6. The method of claim 4, wherein the development termination criterion is met when the cell growth development reaches a predetermined number of discrete steps or a change in the cell growth development from a previous cycle is lower than a predetermined threshold.

7. The method of claim 4, wherein cells represent presence of material or holes at a defined position.

8. The method of claim 7, wherein cells further represent different materials.

9. The method of claim 4, wherein the phenotype of the internal structure is smoothened after the termination of the cell growth development and wherein outer cells represent control points of a higher order spline surface.

10. The method of claim 9, wherein material boundary of a material of different type or holes is represented by patches from a number of different spline surfaces.

11. The method of claim 4, wherein cells move according to forces applied by other cells or environment during the cell growth development.

12. The method of claim 4, wherein cells interact physically in a form of a rigid body interaction during the cell growth development.

13. The method of claim 4, wherein cells are pushed aside when a division occurs to reach a new stable arrangement during the cell growth development.

14. The method of claim 1, wherein the number of parameters of the virtual genotype varies during the step (b) of processing the parameter set.

15. The method of claim 1, wherein the parameters of the virtual genotype define an activity type and an action type of a cell during the cell growth development.

16. The method of claim 15, wherein the activity type is at least one of divide, die, release transcription factor, and produce a cell adhering function.

17. The method of claim 1, wherein the evolutionary algorithm comprises an Evolution Strategy.

18. A computer program product comprising a computer readable storage medium structured to store instructions executable by a processor in a computing device adapted to optimize an internal structure of a body, the instructions, when executed cause the processor to:
(a) encode an initial phenotype design of the internal structure as a parameter set, the initial phenotype design of the internal structure encoded indirectly as a virtual genotype having parameters describing cell growth development of the phenotype using a gene regulatory network;
(b) process the parameter set of the initial phenotype design by an evolutionary algorithm according to at least one predetermined optimization criterion to generate an optimized parameter set, the processing of the parameter set terminated responsive to a termination condition of the evolutionary algorithm being met; and
(c) output data representing the optimized parameter set.
